(19) United States
(12) Patent Application Publication
(10) Pub. No.: US 2018/0025121 A1
(43) Pub. Date: Jan. 25, 2018

(54) SYSTEMS AND METHODS FOR FINER-GRAINED MEDICAL ENTITY EXTRACTION

(71) Applicant: Baidu USA, LLC, Sunnyvale, CA (US)

(72) Inventors: Hongliang Fei, Sunnyvale, CA (US); Shulong Tan, Santa Clara, CA (US); Yi Zhen, San Jose, CA (US); Erheng Zhong, Sunnyvale, CA (US); Chaochun Liu, San Jose, CA (US); Dawen Zhou, Fremont, CA (US); Wei Fan, Sunnyvale, CA (US)

(73) Assignee: Baidu USA LLC, Sunnyvale, CA (US)

(21) Appl. No.: 15/215,393

(22) Filed: Jul. 20, 2016

(51) Int. Cl. G06F 19/00

(52) U.S. Cl. CPC G06F 19/3418; G06F 19/322; G06F 19/3437

(57) ABSTRACT

Systems and methods are disclosed provide improved automated extraction of medical-related information. In embodiments, finer-grained medical-related data, such as medical entities, including symptoms, diseases, dimensions, and temporal information, can be extracted. In embodiments, by extracted finer level medical-related information from an input statement and generating visual displays of that information, a medical professional can readily see relevant medical information that provides medical entities and associated dimension information, as well as evolving history.

### A. TECHNICAL FIELD

The present disclosure relates generally to collecting finer-grained medical entities, and more specifically to systems and methods for extracting finer-grained medical entities for automated medical consulting.

### B. BACKGROUND

With the healthcare industry continually looking to cut costs and waste and improve efficiency, automation of manual tasks can be an important part of a strategy for performance improvement. Automated medical consulting system, such as IBM's Watson Computer system, is revolutionizing traditional healthcare. Watson's natural language, hypothesis generation, and evidence-based learning capabilities allow it to function as a clinical decision support system for use by medical professionals. An automated medical consulting system may be implemented for enhanced medical care for rural areas with limited medical resources, for early detection and/or for severe diseases prevention.

One of the key aspects for the success for an automated medical consulting system is accurately and fully capturing patients' provided information. Unlike standard medical records, patients' input may be noisy voice messages or nonstandard, non-literary free texts. Some traditional entity extraction tools focus on parsing pure entities only and therefore may ignore information about symptom evolving or symptom dimensions such as frequency, intensity, etc.

Therefore, there is a need for systems and methods to automatically identify and extract fine-grained medical entities, including symptom dimension information and temporal information, for automated medical consulting.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that it is not intended to limit the scope of the invention to these particular embodiments. Items in the figures are not to scale.

FIG. 1 shows system architecture of a medical entity parsing system according to embodiments of the present disclosure.

FIG. 2 illustrates a general flow diagram for medical entity dictionary expansion according to embodiments of the present disclosure.

FIG. 3 illustrates a flow diagram for medical entity recognition and classification according to embodiments of the present disclosure.

FIG. 4 illustrates an exemplary flow diagram for machine learning based parser training according to embodiments of the present disclosure.

FIG. 5 illustrates an exemplary flow diagram for online medical entity parsing according to embodiments of the present disclosure.

FIG. 6 illustrates an exemplary flow diagram for dimension search for a parsed medical entity according to embodiments of the present disclosure.

FIG. 7 illustrates an exemplary flow diagram for generating time dependent entity graphs according to embodiments of the present disclosure.

FIG. 8 illustrates exemplary time dependent entity graphs according to embodiments of the present disclosure.

FIG. 9 depicts a simplified block diagram of a computing device/information handling system, in accordance with embodiments of the present disclosure.

### DETAILED DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method on a non-transitory computer-readable medium.

Components, or modules, shown in diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components/modules. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated.

The terms “include,” “including,” “comprise,” and “comprising” shall be understood to be open terms and any lists that follow are examples and not meant to be limited to the listed items. Any headings used herein are for organizational purposes only and shall not be used to limit the scope of the description or the claims. Each reference mentioned in this patent document is incorporate by reference herein in its entirety.

Furthermore, one skilled in the art shall recognize that: (1) certain steps may optionally be performed; (2) steps may not be limited to the specific order set forth herein; (3) certain steps may be performed in different orders; and (4) certain steps may be done concurrently.

General Overview.

Various embodiments of the present disclosure relate to systems and methods to collect fine-grained medical entities, including symptom dimension and temporal information, for automated medical consulting. In embodiments, to parse medical entities and dimension information as well as evolving history, an entity dictionary is expanded and symptom dimensions are recognized by leveraging large online medical forum data. In embodiments, the enriched dictionary and forum data is used to generate training data that is used to train a parser model that receiving input statements and outputs medical-related entities. The phrase “input statement” shall be understood to cover statements, questions, one or more sentences, one or more questions, one or more phrases, or any combination thereof. In embodiments, time-dependent graphs are constructed to encode the temporal information of entities and entity dimensions in a readily understandable manner.

In accordance with embodiments, one or more standard medical entity dictionaries, such as dictionary used in MedMD or MedTerms, may be used as a beginning for medical entities extraction. Additional resources may be used to expand/enrich the medical entity dictionaries to include more non-literal entities with adjectives/adverbs. The additional resources may be online medical forum messages or posts, which may comprise structured or non-structured text. As discussed herein, the enriched/expanded medical entity dictionaries can be used to help extract finer-grained medical entities for better diagnosis.

In embodiments, machine learning-based parser training is implemented using training data collected from both the enriched/expanded medical entity dictionaries and medical forum data. Online medical forum data may have medical entity tags associated with text. Furthermore, in embodiments, the enriched medical dictionary can be used to tag parts of the medical forum data via keyword matching for entities without associated tags. Various state-of-the-art supervised learning algorithms, such as deep neural networks, conditional random field, may be used for the parsing training. After training, the trained parsing model may then be deployed for entity parsing to extract parsed entities from an input of sentence.

In embodiments, a rule-based method, the trained parsing model, or both may be used to parse an input statement. Compared to the trained parsing model, the rule-based method may have better precision for parsing terms as medical entities. On the other hand, the trained parsing model may provide wider coverage than the rule-based method. In embodiments, the two methods may be utilized in combination for improved parsing performance.

In embodiments, each parsed entity (which may be, for example, a symptom or dimension) may be searched for descriptive modifiers (e.g., adjective/adverb modifiers). If a modifier exists, the modification may be mapped to a measurable level. For example, a symptom entity may be checked for applicable dimensional information, which may be the symptom's frequency, intensity and duration. For example, a frequency dimension of “sometimes” may be mapped to a severity of 1, “often” may be mapped to a severity of 2, and “always” may be mapped to a severity of 3. In embodiments, the expanded medical dictionary may cover the modification mapping when the adjective/adverb modification occurs in the middle of a symptom.

In embodiments, a time-dependent entity graph may be generated. In embodiments, a time-dependent entity graph is a directed graph for a temporal segment of an input statement, in which each node represents a medical entity/dimension and each edge decodes an existence relationship. For each time period in a user's description, there may be such a graph. The time-dependent entity graph provides a vivid temporal illustration for a medical practitioner.

Certain features and advantages of the present invention have been generally described here; however, additional features, advantages, and embodiments are presented herein will be apparent to one of ordinary skill in the art in view of the drawings, specification, and claims hereof. Accordingly, it should be understood that the scope of the invention is not limited by the particular embodiments disclosed this overview.

Embodiments of System Architectures and Workflows.

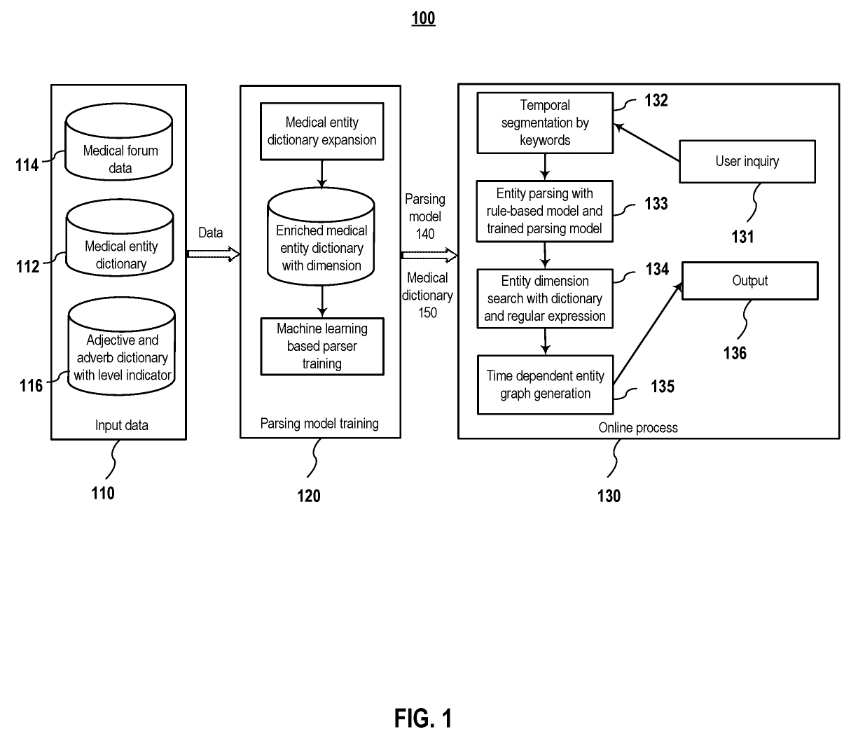

FIG. 1 depicts system architecture of a medical entity parsing system 100 according to embodiments of the present disclosure. In embodiments, a plurality of data sources 110 are used for parsing model training 120 to obtain a parsing model 140 and an enriched medical entity dictionary 150. The parsing model 140 and an enriched medical entity dictionary 150 are then used in an online process 130 to generate parsed medical entities and applicable time-dependent entity graphs from a user input.

In embodiments, the medical entity parsing system is built with supporting methods to collect medical entities. The parsed entities may include both literal terms and non-literal terms. Non-literal terms are the entities that cannot be found in ordinary medical knowledge database (e.g. WebMD). Such non-literal terms may typically be from patients/users without medical knowledge. Parsed entities, e.g. symptoms, are mined for dimension to describe symptoms. For a parsed entity, a temporal order may be derived and one or more time frames may be assigned for graphic description. In such a system, all the discovered knowledge may be organized in a meaningful and compact way, such as graphical diagrams.

In embodiments, the data sources 110 comprise a medical entity dictionary (an initial or existing enhanced or expanded medical entity dictionary) 112, an additional medical data source or sources 114, and a collection of adjective/adverb terms 116. The additional medical data source 114 may be online medical forum data, such as posts, statements, messages from forum users. For example, in Baidu Knows (Zhidao) question/answering platform, there are around 10 million medical questions posted on a daily basis. Those questions may contain a great deal of medical entity information not completely covered by the medical entity dictionaries 112, which may be obtained from sources such as WebMD or MedTerms, etc. The collection of adjective/adverb terms 116 may comprise adjective/adverb terms typically used for descripting the medical entities (e.g. frequency, intensity, duration, etc.). In some languages, such as Chinese, adjective/adverb terms may be commonly used together when descripting a medical entity, and there are many different ways to describe a medical entity such as a symptom. It would be more efficient for automatic medical diagnosis if the parsing system can quickly and accurately identify those description variations and associate them into one entity. In embodiments, the adjective/adverb terms may also include level indicator to quantitatively describe a medical entity.

In embodiments, the data sources 110 are used for parsing model training 120 to obtain a parsing model and an enriched medical entity dictionary. During the parsing model training, the medical entity dictionary is first expanded to an enriched medical entity dictionary with dimension information for medical entities.

After training, the parsing model and the enriched medical entity dictionary may be used to generate parsed medical entities from an input statement or statements. In embodiments, during the parsing process, a user's inquiry 131 is segmented into multiple temporal segments 132, which are then extracted using a rule-based model in concert with a trained parsing model, to obtain parsed entities 133. In embodiments, each parsed entity may be checked 134 for dimension information. In embodiments, one or more time-dependent entity graphs may be generated 134 from the results. The time-dependent entity graph is a directed graph with each node represents a medical entity/dimension, and edge decodes the existence relationship. In embodiments, for each time period in user's description, such a graph may be generated. Finally, the generated time-dependent entity graphs and other associated information are output 135 to the user via an output interface. The time-dependent entity graph or graphs provide a vivid temporal illustration for a medical practitioner.

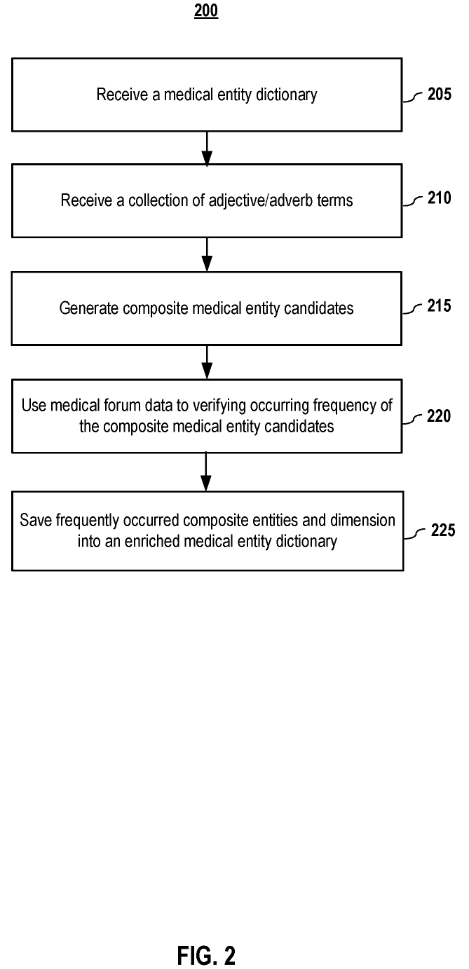

FIG. 2 illustrates a general flow diagram for medical entity dictionary expansion according to embodiments of the present disclosure. In step 205, a medical entity dictionary is received. The medical entity dictionary may be an available standard dictionary, such as WebMD or MedTerm, etc. In step 210, a collection of descriptive adjectives and/or adverbs terms are received. The collection of descriptive terms may also be available as an adjective/adverb dictionary. The adjective/adverb terms are typically used for describing the medical entities, especially in some languages, such as Chinese, in which modifiers occur in the middle of entities. There are many different ways to describe a medical entity (e.g., a symptom, disease, etc.) based on combinations of the adjectives and/or adverbs terms and the medical entity terms from the medical entity dictionary. In step 215, multiple composite entity candidates related to the medical entity are generated. For example, adjective/adverb terms may be combined with a medical entity to form additional composite medical entity (e.g., disease, symptom, etc.) candidates. In step 220, medical forum data is used to verify occurring frequency of the composite medical entity candidates. The medical forum data may be collected offline from large medical forum, such as Baidu Knows (Zhidao). In step 225, composite medical entity candidates with occurrence frequency in the data that is above a threshold value may be saved together with applicable dimension information into an enriched medical entity dictionary. In embodiments, the enriched medical entity dictionary may be updated periodically (e.g., such as weekly, monthly, or bi-monthly, etc.) or at other times.

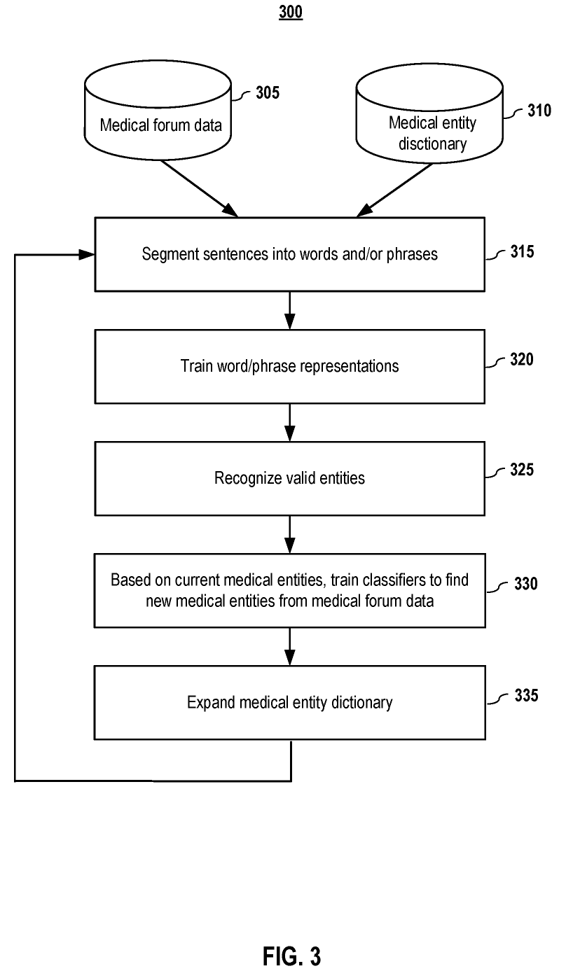

FIG. 3 depicts a flow diagram 300 for medical entity dictionary expansion with valid entity recognition and classification, according to embodiments of the present disclosure. Medical dictionary 310 may be utilized to identify all the initial medical entities occurring in the medical forum data. Sentences from Medical forum data 305 is segmented into input word/phrase fragments 315. The Medical forum data 305 may be collected from one or more online posts or forums. The sentences may comprise or not comprise initial medical entities. In step 320, training data (e.g., different data batches from the medical forum data 305) may be used for word/phrase representation model training or vector representation model training. For example, word2vec may be used to generate word/phrase representations using the inputted training data. In step 325, valid entities may be identified in the training data. In some embodiments, medical entities words (positive samples) may be identified by word matching. In some embodiments, non-medical entities words (negative samples), such as name and address, by also be identified by ground truth or common sense. Such a data set can be used to train a supervised learning algorithm to predict if a new word is a valid medical entity. In embodiments, sample training data from the medical forum data may be paired with the medical entity dictionary 310 and with other recognized entities to produce ground-truth data for supervised learning of one or more classifiers for new entities. Thus, in step 330, in embodiments, new medical entities may be identified from online medical forum data based on current medical entities by using a trained classifiers module to train classifiers to find new entities. In embodiments, some human auditing may be used to verify the classifying of the new entities. In step 335, the medical entity dictionary is expanded using the newly identified medical entities. In embodiments, the expanded medical entity dictionary may then be used to replace the medical entity dictionary 310, and the process may be repeated until a stop condition is reached. In embodiments, a stop condition may be a number of iterations being reached or the condition that no new entities were found, among other possible stop conditions. Thus, the flow diagram 300 provides an iterative machine learning approach to recognize medical entities.

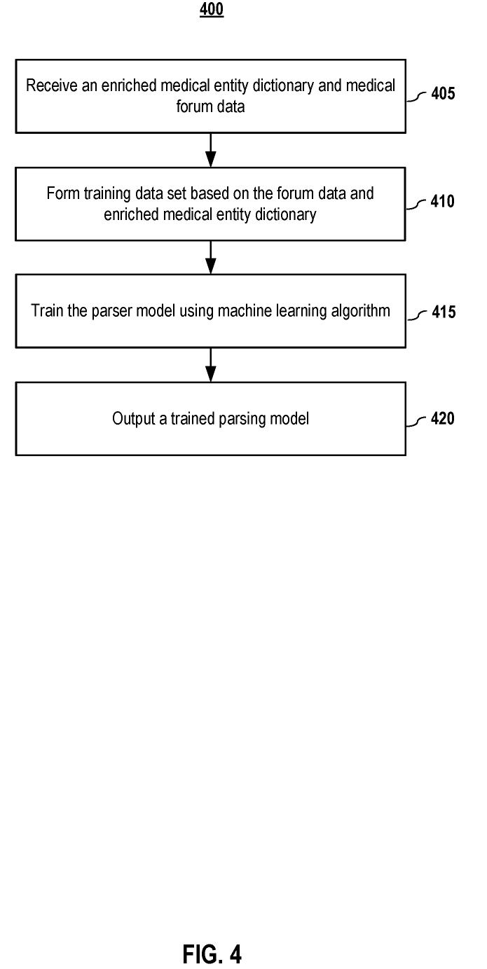

FIG. 4 illustrates an exemplary flow diagram for machine learning-based parser training according to embodiments of the present disclosure. An enriched medical entity dictionary and medical forum data are received in step 405. In embodiments, the medical forum data for parser training may not be the same as the forum data used for expanding medical entity dictionary. In embodiments, the medical forum data are selected from online posts, messages, statements, etc., posted in the medical forum. In step 410, a training data set is formed based on the online medical forum data and the enriched medical entity dictionary. In embodiments, the training data comprises users' statements or inquiries with corresponding medical entities in the statements or inquiries being identified to form ground-truth data. In embodiments, the medical entities are existing medical entity tags associated with the statement inquiry texts. For those statements or inquiries without associated tags, the enriched medical entity dictionary may be used to tag the medical entities in those statements using keyword matching. In step 415, a parser model is trained using one or more supervised learning algorithms, such as deep neural networks, conditional random field, etc. In step 420, a trained parsing model is output after training. In some embodiments, the parser model may be trained multiple rounds using multiple batches of online medical forum data for model refining and efficiency improvements.

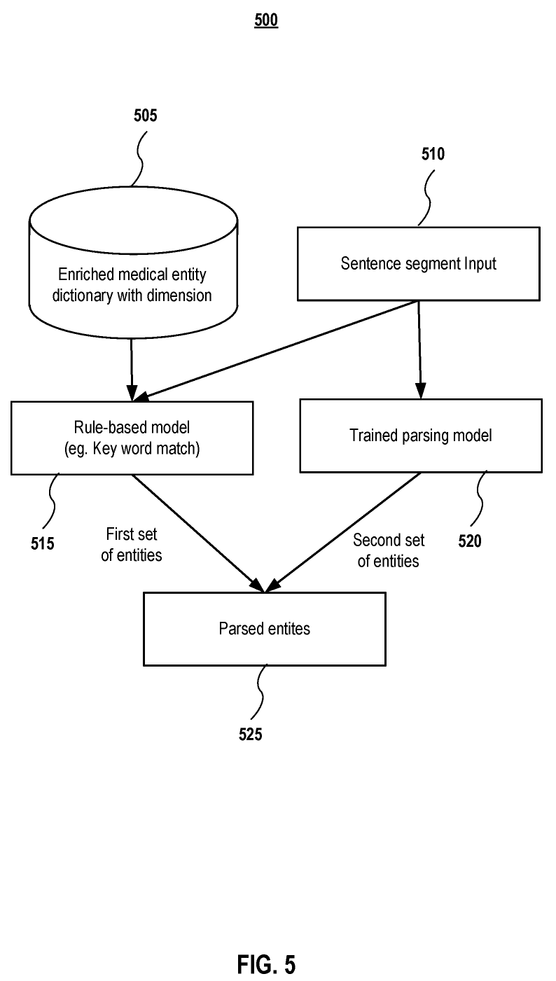

FIG. 5 illustrates an exemplary flow diagram for online medical entity parsing according to embodiments of the present disclosure. In step 510, a user's medical inquiry input is received. The inquiry may be segmented into multiple temporal segments using a rule-based approach that identifies temporal-related expression or ques in the inquiry. In embodiments, the segments are examined using a rule-based model 515 and the trained parsing model 520 to identify entities. In embodiments, the rule-based model 515 may use the enriched medical entity dictionary 505 for keyword matching to examine the sentence segments and obtain a first set of medical entities in a segment. In embodiments, the trained parsing model 520 is used to parse the sentence segment and get a second set of medical entities. In embodiments, a final set of parsed entities 525 is then obtained from the first set of medical entities and the second set of medical entities. In embodiments, a final set of parsed entities 525 is a combination of the first set of medical entities and the second set of medical entities. In embodiments, the combination may be a union of the first set of medical entities and the second set of medical entities minus any duplicate entities within the first set of medical entities and the second set of medical entities. Compared to the trained parsing model, the rule-based method may have better precision to guarantee parsed terms as real medical entities. On the other hand, the trained parsing model may provide wider coverage than the rule-based method. The two models may be utilized in combination for optimized parsing performance, or may be used individually.

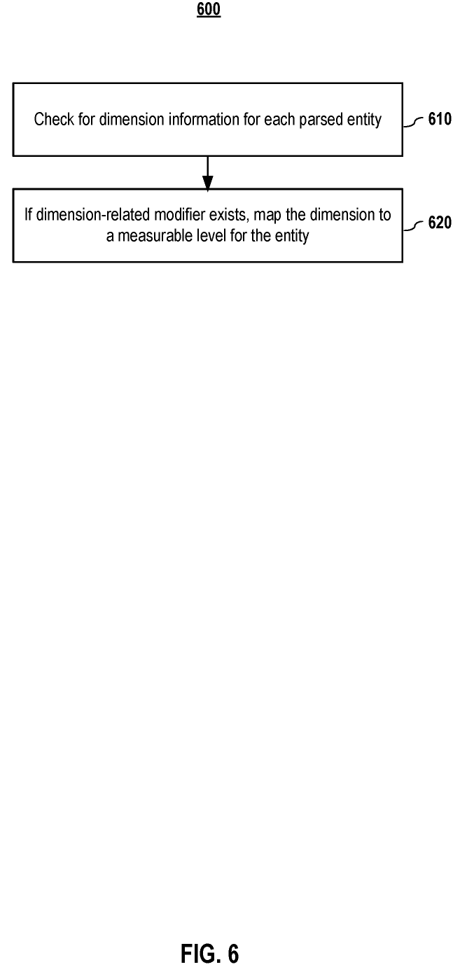

FIG. 6 illustrates an exemplary flow diagram 600 for dimension searching for a parsed medical entity according to embodiments of the present disclosure. In step 610, each parsed entity is verified for dimension information, e.g. whether it is modified by descriptive adjectives and/or adverbs. For example, the dimension may refer to a frequency, intensity, or duration of a symptom entity. In step 620, for entities with dimension, the dimension information (or modifiers) may be mapped to a measurable level. For example, for frequency dimension that modifies a headache entity, level 1 may be assigned to the headache entity for headaches described to occur “sometimes”, level 2 may be assigned when the modifier “often” is used, and level 3 may be assigned if “always” is the modifies that is used.

In embodiments, the expanded medical dictionary may be utilized to cover the dimension identification when descriptive adjectives/adverbs occur in the middle of a parsed entity. In embodiments, neighboring keyword matching against an adjective/adverb term collection and regular expression matching may be also used for identifying the dimension modifiers.

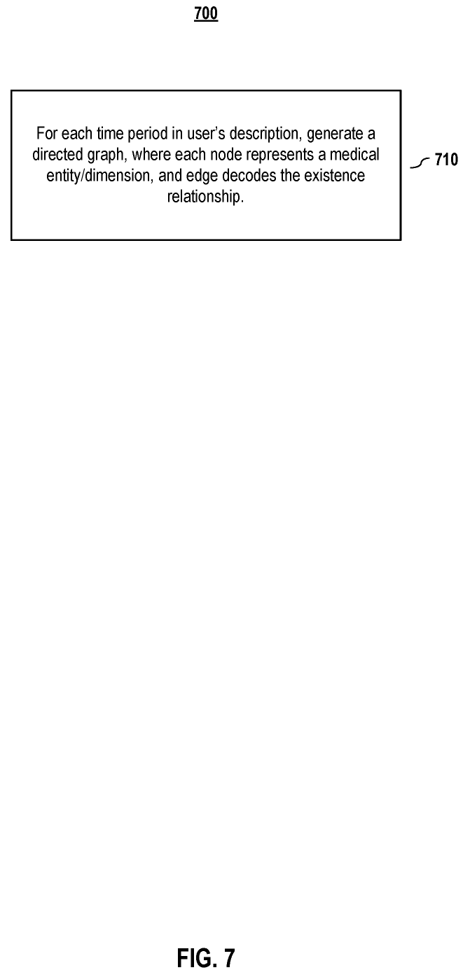

FIG. 7 illustrates an exemplary flow diagram 700 for generating time-dependent entity graphs according to embodiments of the present disclosure. In step 710, for each time period in the user's statement, a directed graph may be generated. The directed graph is a graph comprising one or more nodes and one or more edges, in which each node represents a medical entity/dimension, and edge decodes the existence relationship. For description with multiple timelines, multiple graphs may be generated. For example, for a description of “3 days ago, my head badly hurts. Today my headache has reduced, but my body temperature is 103 F”, two graphs may be generated to correspond the time periods of “3 days ago” and “today” respectively.

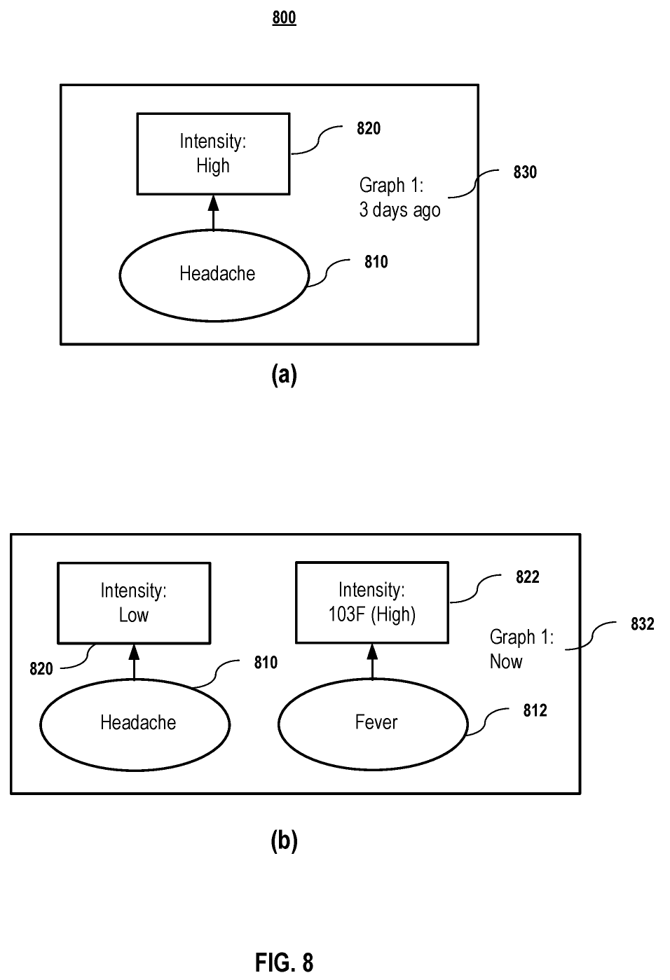

FIG. 8 shows exemplary generated time-dependent entity graphs 800 corresponding to an exemplary user input of “3 days ago, my head badly hurts. Today my headache has reduced, but my body temperature is 103 F”. FIG. 8 (a) is a first time-dependent entity graph associated with a first timeline for the user's input. The entity graph comprises an entity (or symptom) icon 810, its applicable level indicator 820 for quantitative description and a timeline note 830. The level indicator 820 may be color coded to identify different levels. FIG. 8 (b) is a second time-dependent entity graph associated with a second timeline for the user's input. Besides existing entity 810, the entity graph of FIG. 8(b) comprises an additional entity (or symptom) icon 812 and its applicable level indicator 822 and a second timeline note 832. Furthermore, the level indicator 820 may also be updated to reflect any changes to the level associated to the entity 810. In some embodiments, the color coding (or other level indication schemes) method may be the same for all included entities. For example, a red color may be used for both entity 810 and 820 for a more serious level. The time-dependent entity graph provides a vivid temporal illustration for a medical practitioner. Although exemplary entity graphs are shown in FIG. 8, it is understood that other ways to present temporal information for entity may also be implemented. Such variation may also be within the scope of this invention. For example, the level indicator may be integrated together with the entity (or symptom) icon with different icon color for dimension information.

In embodiments, aspects of the present patent document may be directed to or implemented on information handling systems/computing systems. For purposes of this disclosure, a computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes. For example, a computing system may be a personal computer (e.g., laptop), tablet computer, phablet, personal digital assistant (PDA), smart phone, smart watch, smart package, server (e.g., blade server or rack server), a network storage device, or any other suitable device and may vary in size, shape, performance, functionality, and price. The computing system may include random access memory (RAM), one or more processing resources such as a central processing unit (CPU) or hardware or software control logic, ROM, and/or other types of memory. Additional components of the computing system may include one or more disk drives, one or more network ports for communicating with external devices as well as various input and output (I/O) devices, such as a keyboard, a mouse, touchscreen and/or a video display. The computing system may also include one or more buses operable to transmit communications between the various hardware components.

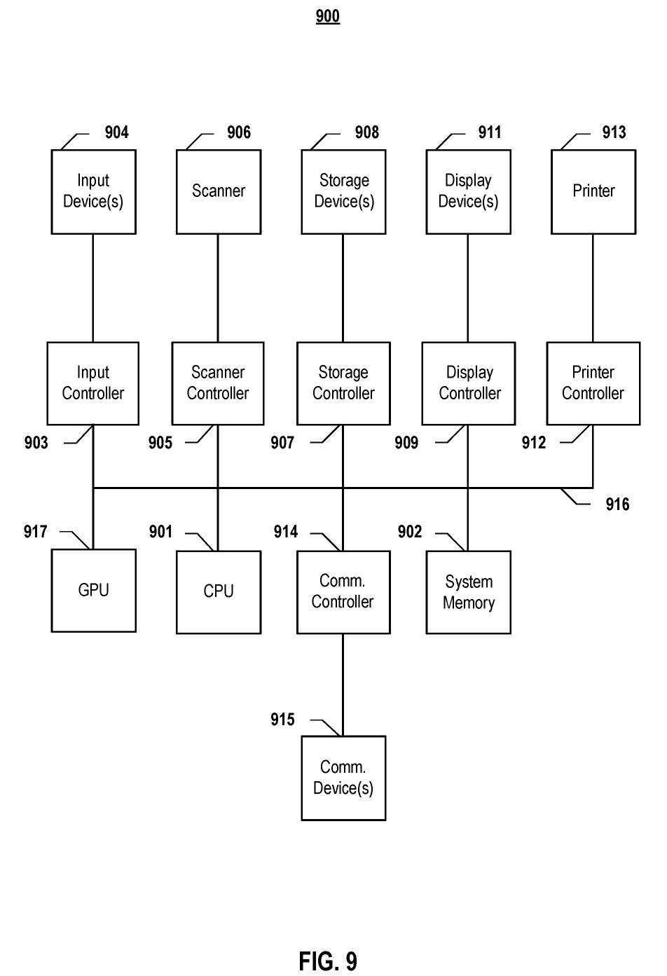

FIG. 9 depicts a block diagram of a computing system 900 according to embodiments of the present invention. It will be understood that the functionalities shown for system 900 may operate to support various embodiments of a computing system—although it shall be understood that a computing system may be differently configured and include different components. As illustrated in FIG. 9, system 900 includes one or more central processing units (CPU) 901 that provides computing resources and controls the computer. CPU 901 may be implemented with a microprocessor or the like, and may also include one or more graphics processing units (GPU) 917 and/or a floating point coprocessor for mathematical computations. System 900 may also include a system memory 902, which may be in the form of random-access memory (RAM), read-only memory (ROM), or both.

A number of controllers and peripheral devices may also be provided, as shown in FIG. 9. An input controller 903 represents an interface to various input device(s) 904, such as a keyboard, mouse, or stylus. There may also be a scanner controller 905, which communicates with a scanner 906. System 900 may also include a storage controller 907 for interfacing with one or more storage devices 908 each of which includes a storage medium such as magnetic tape or disk, or an optical medium that might be used to record programs of instructions for operating systems, utilities, and applications, which may include embodiments of programs that implement various aspects of the present invention. Storage device(s) 908 may also be used to store processed data or data to be processed in accordance with the invention. System 900 may also include a display controller 909 for providing an interface to a display device 911, which may be a cathode ray tube (CRT), a thin film transistor (TFT) display, or other type of display. The computing system 900 may also include a printer controller 912 for communicating with a printer 913. A communications controller 914 may interface with one or more communication devices 915, which enables system 900 to connect to remote devices through any of a variety of networks including the Internet, an Ethernet cloud, a Fiber Channel over Ethernet (FCoE)/Data Center Bridging (DCB) cloud, a local area network (LAN), a wide area network (WAN), a storage area network (SAN) or through any suitable electromagnetic carrier signals including infrared signals.

In the illustrated system, all major system components may connect to a bus 916, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

It should be understood that various system components may or may not be in physical proximity to one another. In addition, programs that implement various aspects of this invention may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices.

Embodiments of the present invention may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present invention may further relate to computer products with a non-transitory, tangible computer-readable medium that have computer code thereon for performing various computer-implemented operations. The media and computer code may be those specially designed and constructed for the purposes of the present invention, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Embodiments of the present invention may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present invention. One skilled in the art will also recognize that a number of the elements described above may be physically and/or functionally separated into sub-modules or combined together.

It will be appreciated to those skilled in the art that the preceding examples and embodiments are exemplary and not limiting to the scope of the present invention. It is intended that all permutations, enhancements, equivalents, combinations, and improvements thereto that are apparent to those skilled in the art upon a reading of the specification and a study of the drawings are included within the true spirit and scope of the present invention.

It shall be noted that elements of the claims, below, may be arranged differently including having multiple dependencies, configurations, and combinations. For example, in embodiments, the subject matter of various claims may be combined with other claims.

1. A computer-implemented method to extracting medical entities from an input statement, the method comprising:
segmenting an input statement into one or more temporal segments based upon one or more temporal cues in the input statement; and
for a temporal segment from the one or more temporal segments:
parsing the temporal segment using a rule-based model and a medical entity dictionary comprising a set of medical-related terms or phrases to obtain a first set of parsed medical entities;
parsing the temporal segment using a parsing model that receives as an input the temporal segment and outputs a second set of parsed medical entities in the temporal segment; and
output a final set of parsed medical entities based on the first set of parsed medical entities and the second set of parsed medical entities.

2. The computer-implemented method of claim 1 wherein the final set of parsed medical entities is a combination of the first set of parsed medical entities and the second set of parsed medical entities.

3. The computer-implemented method of claim 2 wherein the combination of the first set of parsed medical entities and the second set of parsed medical entities is a union of the first set of parsed medical entities and the second set of parsed medical entities minus any entities that are duplicative between the first set of medical entities and the second set of medical entities.

4. The computer-implemented method of claim 1 wherein the rule-based model uses the medical entity dictionary for keyword matching to identify medical entities in the temporal segment.

5. The computer-implemented method of claim 4 wherein the medical entity dictionary is an enriched medical entity dictionary obtained by performing the steps comprising:
generating a set of candidate composite medical entities by combining each term or phrase from a set of terms or phrases from an initial medical entity dictionary with each modifier from a set of modifiers;
using medical data to determine an occurrence frequency for each of the candidate composite medical entities; and
adding to the medical entity dictionary each candidate composite medical entities with an occurrence frequency that exceeds a threshold value.

6. The computer-implemented method of claim 5 wherein the parsing model is trained with a training data set formed using the enriched medical entity dictionary and medical forum data.

7. The computer-implemented method of claim 1 further comprising:
for each medical entity within the final set of parsed medical entities, determining whether the medical entity is modified by a descriptive modifier; and
responsive to a descriptive modifier existing, mapping the descriptive modifier to one or more levels.

8. The computer-implemented method of claim 7 further comprising generating a directed graph for each temporal segment in which each a parsed medical entity from the final set of parsed medical entities for the temporal segment is a node that represents the medical entity or dimension and each edge represents a relationship between nodes that are connected by the edge.

9. The computer-implemented method of claim 8 wherein the node representing dimension is coded to identify a measurable level for quantitative description of an associated parsed medical entity.

10. A method for creating a system to extract medical from an input statement, the method comprising:
receiving a medical entity dictionary comprising a set of medical-related terms or phrases and medical forum data;
forming a set of samples for a training dataset using at least some of the medical forum data and at least some of the medical entity dictionary that comprises, for each sample, a medical statement from the medical forum data and corresponding medical entities in the medical statement;
using at least some of samples in the training dataset to train a parsing model to identify medical entities in an input statement; and
using at least some of terms and phrases in the medical entity dictionary to form a rule-based model to identify medical entities in an input statement.

11. The method of claim 10 wherein the medical entity dictionary is an enriched medical entity dictionary expanded from an initial medical entity dictionary using a set of modifiers comprising one or more adjectives, one or more adverbs, or a combination thereof.

12. The method of claim 11 wherein the enriched medical entity dictionary is obtained by performing the steps comprising:
generating a set of candidate composite medical entities by combining each term or phrase from a set of terms or phrases from the initial medical entity dictionary with each modifier from the set of modifiers;
using medical data to determine an occurrence frequency for each of the candidate composite medical entities; and
adding to the medical entity dictionary each candidate composite medical entities with an occurrence frequency that exceeds a threshold value.

13. The method of claim 10 wherein the medical entities in a sample are identified by existing medical entity tags associated with the sample.

14. The method of claim 10 further comprising forming a temporal segmenter that segments an input sentence into one or more temporal segments using temporal-related keywords and associated rules.

15. The method of claim 10 further comprising forming an entity-dimension searcher that, for a medical entity identified in the input statement by either the parsing model or the rule-based model, determines whether the medical entity is modified by a descriptive modifier, and that, responsive to a descriptive modifier existing, maps the descriptive modifier to one or more levels.

16. The method of claim 15 wherein assigning a level to at least some of the descriptive modifiers.

17. The method of claim 15 generating a graphing module that, for a temporal segment of the input statement, generates a directed graph for the temporal segment by creating a node for each medical entity identified the temporal segment by either the parsing model or the rule-based model and by creating an edge between nodes that have a relationship.

18. A system for medical entity recognition comprising:
one or more processors;
a medical entity dictionary, communicatively accessible by at least one of the one or more processors, the medical entity dictionary comprising a set of medical-related terms or phrases;
a non-transitory computer-readable medium or media comprising one or more sequences of instructions which, when executed by at least one processor of the one or more processors, causes the steps to be performed:
segmenting an input statement into one or more temporal segments based upon one or more temporal cues in the input statement; and
for a temporal segment from the one or more temporal segments:
parsing the temporal segment using a rule-based model and the medical entity dictionary to obtain a first set of parsed medical entities;
parsing the temporal segment using a parsing model that receives as an input the temporal segment and outputs a second set of parsed medical entities in the temporal segment; and
output a final set of parsed medical entities based on the first set of parsed medical entities and the second set of parsed medical entities.

19. The system of claim 18 wherein medical entity dictionary is an enriched medical entity dictionary obtained by performing the steps comprising:
generating a set of candidate composite medical entities by combining each term or phrase from a set of terms or phrases from an initial medical entity dictionary with each modifier from a set of modifiers;
using medical data to determine an occurrence frequency for each of the candidate composite medical entities; and
adding to the medical entity dictionary each candidate composite medical entities with an occurrence frequency that exceeds a threshold value.

20. The system of claim 18 wherein the non-transitory computer-readable medium or media further comprises one or more sequences of instructions which, when executed by at least one processor of the one or more processors, causes the steps to be performed
for each medical entity within the final set of parsed medical entities, determining whether the medical entity is modified by a descriptive modifier; and
responsive to a descriptive modifier existing, mapping the descriptive modifier to one or more levels.
